(19) United States
(12) Patent Application Publication
(10) Pub. No.: US 2015/0181430 A1
(43) Pub. Date: Jun. 25, 2015

(54) SYSTEMS AND METHODS FOR COMMUNICATION USING A BODY AREA NETWORK

(71) Applicants: Kwan Ho Lee, Mountain View, CA (US); Erik S. Gamez Rodriguez, Salt Lake, UT (US); Younguk Chang, Milpitas, CA (US); Sean T. Dunford, David, FL (US); Akihiro Takagi, San Mateo, CA (US); Mindy Chang, Millbrae, CA (US); Ulun Karacaoglu, San Diego, CA (US); Anand S. Konanur, Sunnyvale, CA (US)

(72) Inventors: Kwan Ho Lee, Mountain View, CA (US); Erik S. Gamez Rodriguez, Salt Lake, UT (US); Younguk Chang, Milpitas, CA (US); Sean T. Dunford, David, FL (US); Akihiro Takagi, San Mateo, CA (US); Mindy Chang, Millbrae, CA (US); Ulun Karacaoglu, San Diego, CA (US); Anand S. Konanur, Sunnyvale, CA (US)

(21) Appl. No.: 14/134,766

(22) Filed: Dec. 19, 2013

(51) Int. Cl. H04W 12/08; G06F 21/32

(52) U.S. Cl. CPC H04W 12/08; G06F 21/32

(57) ABSTRACT

The present disclosure relates to computer-implemented systems and methods for establishing communication using a body area network. A system may receive, by a capacitive sensor, a touch interaction from a user. Furthermore, the system may determine, by the capacitive sensor based at least in part on the touch interaction, a change in capacitance. In addition, the system may transmit, via the user's body in response to the change in capacitance, a request to a user device for credential information. The system may also receive, from the user device via the user's body, the credential information.

### TECHNICAL FIELD

The present disclosure generally relates to wireless communication, and in particular, to communication using a body area network.

### BACKGROUND

Many operating systems and other applications may request input of credential information from users into order to log in. Due to the multitude of such applications, a user may be associated with numerous combinations of user identifiers, passwords, and other credential information for different applications. Remembering particular combinations and manually inputting those combinations for the correct corresponding application may be difficult and tedious in certain situations.

### BRIEF DESCRIPTION OF THE DRAWINGS

Reference will now be made to the accompanying figures and diagrams, which are not necessarily drawn to scale, and wherein:

FIG. 1 shows a block diagram of a system for communication using a body area network, according to one or more example embodiments.

FIG. 2 shows a data flow diagram for communication using a body area network, according to one or more example embodiments.

FIG. 3 shows a flow diagram for communication using a body area network, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” refers, in general, to a wireless communication device, and more particularly to one or more of the following: a portable electronic device, a telephone (e.g., cellular phone, smartphone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other receiving device.

As used herein, unless otherwise specified, the term “transmitter” may refer to any device or component capable of transmitting data, signals, information, etc. For example, a transmitter may also include an antenna or any other transmission device.

As used herein, unless otherwise specified, the term “transceiver” may refer to any device or component capable of performing the functions of a receiver and/or a transmitter.

According to certain embodiments, the functionality provided by the receiver and the transmitter may be included in a single transceiver device.

The present disclosure relates to computer-implemented systems and methods for communication using a body area network. According to one or more embodiments of the disclosure, a system is provided. The system may include a capacitive sensor. The system may also include at least one memory for storing data and computer-executable instructions. Additionally, the system may also include at least one processor to access the at least one memory and to execute the computer-executable instructions. Furthermore, the at least one processor may be configured to execute the instructions to receive, by the capacitive sensor, a touch interaction from a user. Additionally, the at least one processor may be configured to execute the instructions to determine, by the capacitive sensor based at least in part on the touch interaction, a change in capacitance. The at least one processor may also be configured to execute the instructions to transmit, via the user's body in response to the change in capacitance, a request to a personal mobile device for credential information. The at least one processor may also be configured to execute the instructions to receive, from the personal mobile device via the user's body, the credential information.

According to one or more embodiments of the disclosure, a method is provided. The method may include receiving, by a computer, a touch interaction from a user. The computer may include one or more processors and a capacitive sensor. The method may also include transmitting, via the user's body in response to the change in capacitance, a request to a personal mobile device for credential information. Additionally, the method may include receiving, from the personal mobile device via the user's body, the credential information.

According to one or more embodiments of the disclosure, a non-transitory computer-readable medium is provided. The non-transitory computer-readable medium may have embodied thereon instructions executable by one or more processors. The instructions may cause the one or more processors to receive, by a capacitive sensor, a touch interaction from a user. Additionally, the computer-readable medium may include instructions to determine, by the capacitive sensor based at least in part on the touch interaction, a change in capacitance. Moreover, the computer-readable medium may include instructions to transmit, via the user's body in response to the change in capacitance, a request to a personal mobile device for credential information. Further still, the computer-readable medium may include instructions to receive, from the personal mobile device via the user's body, the credential information.

According to one or more embodiments of the disclosure, a mobile device is provided. The mobile device may include a transceiver. The mobile device may also include at least one memory for storing data and computer-executable instructions. Additionally, the mobile device may also include at least one processor to access the at least one memory and to execute the computer-executable instructions. Furthermore, the at least one processor may be configured to receive, from a user device via a user's body, an indication to transmit credential information associated with the user and transmit, by the transceiver via the user's body, the credential information to the user device.

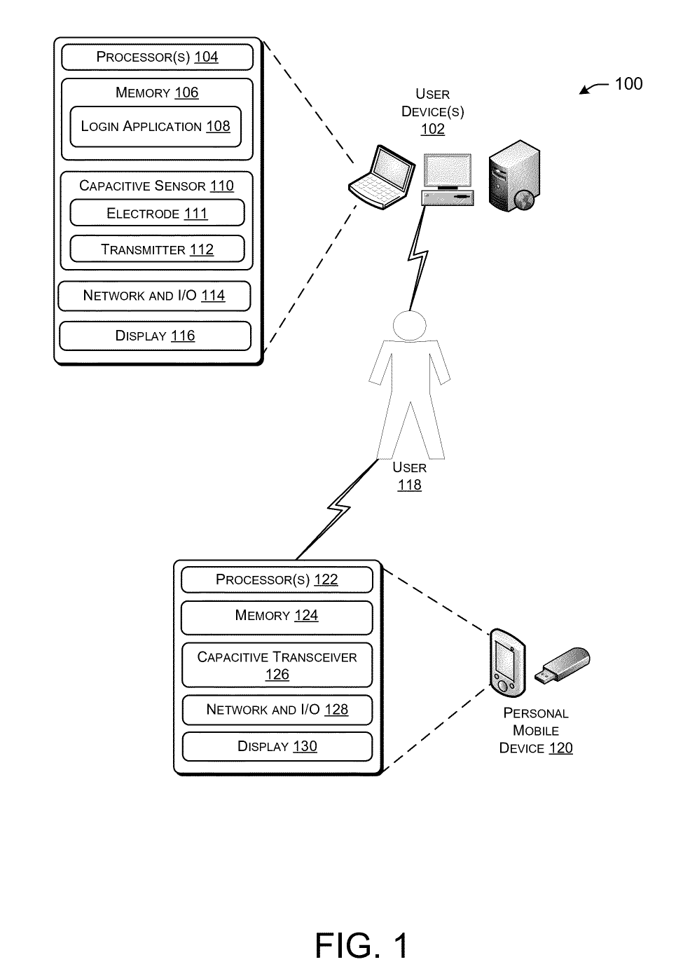

The above principles, as well as others, are now illustrated with reference to FIG. 1, which depicts a system 100 for communication using a body area network. The system 100 may include a user device 102 having one or more computer processors 104, a memory 106 which may store a login application 108, a capacitive sensor 110 including an electrode 111 and a transmitter 112, network and input/output (I/O) interfaces 114, and a display 116 in communication with each other. The system 100 may also be configured to facilitate communication between the user device 102 and one or more personal mobile devices 120 by using the user 118 as a medium for the communication. The personal mobile device 120 may include one or more computer processors 122, a memory 124, a capacitive transceiver 126, network and input/output (I/O) interfaces 128, and a display 130 in communication with each other. It will be appreciated that all transceivers, receivers, transmitters, and/or the like described with respect to the user device 102 and the personal mobile device(s) 120 may be configured to receive and/or transmit any type of radio signals (e.g., Body Area Network (BAN) signals, WiFi radio signals, Bluetooth radio signals, Bluetooth Low-Energy radio signals, etc.).

The processors 104/122 may comprise one or more cores and may be configured to access and execute (at least in part) computer-readable instructions stored in the memory 106/124. The one or more processors 104/122 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user devices 102 may also include a chipset (not shown) for controlling communications between the one or more processors 104/122 and one or more of the other components of the user device 102. In certain embodiments, the user device 102 may be based on an Intel® architecture or an ARM® architecture, and the processor(s) and chipset may be from a family of Intel® processors and chipsets. The one or more processors 104/122 may also include one or more application-specific integrated circuits (ASICs) or application-specific standard products (ASSPs) for handling specific data processing functions or tasks.

The memory 106/124 may comprise one or more computer-readable storage media (CRSM). In some embodiments, the memory 106/124 may include non-transitory media such as random access memory (RAM), flash RAM, magnetic media, optical media, solid-state media, and so forth. The memory 106/124 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106/124 may store an operating system that includes a plurality of computer-executable instructions that may be implemented by the processor 104/122 to perform a variety of tasks to operate the interface(s) and any other hardware installed on the user device 102. The memory 106/124 may also store content that may be displayed by the user device 102 or transferred to other devices (e.g., headphones) to be displayed or played by the other devices. The memory 106/124 may also store content received from the other devices. The content from the other devices may be displayed, played, or used by the user device 102 to perform any necessary tasks or operations that may be implemented by the processor 104/122 or other components in the user device 102/personal mobile device 120.

The network and I/O interfaces 114/128 may also comprise one or more communication interfaces or network interface devices to provide for the transfer of data between the user device 102 and another device (e.g., network server) via a network (not shown). The communication interfaces may include, but are not limited to: body area networks (BANs), personal area networks (PANs), wired local area networks (LANs), wireless local area networks (WLANs), wireless wide area networks (WWANs), and so forth. The user device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2012, published Mar. 29, 2012;), the Bluetooth standard, or any other wireless standard and/or a combination thereof. The wireless system (not shown) may include a transmitter and a receiver or a transceiver capable of operating in a broad range of operating frequencies governed by the IEEE 802.11 wireless standards. The communication interfaces may utilize acoustic, radio frequency, optical, or other signals to exchange data between the user device 102 and another device such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 116/130 may include, but is not limited to, a liquid crystal display, a light-emitting diode display, or an E-Ink™ display as made by E Ink Corp. of Cambridge, Mass. The display may be used to show content to a user in the form of text, images, or video. In certain instances, the display may also operate as a touch screen display that may enable the user to initiate commands or operations by touching the screen using certain finger or hand gestures.

Broadly, a user 118 may wish to securely log in to an operating system stored in a memory 106 of a user device 102. The user device 102 may include a capacitive sensor 110, which may include an electrode 111 and a transmitter 112. The capacitive sensor 110 may be externally coupled to the user device 102, or alternatively, the capacitive sensor 110 may be integrated on the user device 102. For instance, the capacitive sensor 110 may be integrated into all and/or a portion of the display 116 (e.g., behind the display 116). As another example, the capacitive sensor 110 may be integrated into the frame and/or chassis of the user device 102.

In addition, the user 118 may be coupled to a personal mobile device 120, which may include a capacitive transceiver 126. In certain embodiments, the personal mobile device 120 may be touching the user 118. For instance, the personal mobile device 120 may be a smartphone, a personal digital assistant, a tablet and/or the like that is held by the user 118. In other implementations, the personal mobile device 120 may be a wearable item or accessory including, but not limited to, a watch, a necklace, a headband, a bracelet, a pin, a badge, a belt, or a ring. To this end, the capacitive transceiver 126 may be composed of any capacitive and/or flexible material that may be shaped and/or otherwise contoured to a user's 118 body.

According to one or more embodiments, the capacitive sensor 110 on the user device 102 may be configured to determine, detect, and/or otherwise receive a touch interaction from the user 118. The touch interaction may include a finger press, a swipe gesture, and/or any other type of touch event. To this end, the touch interaction may indicate that the user 118 wishes to log in to the operating system of the user device 102. As the user 118 touches the capacitive sensor 110, the electrode 111 may be configured to detect a change in capacitance of the capacitive sensor 110. Upon determining the capacitance change by the electrode 111, the transmitter 112 may be configured to transmit an indication or request for the user's credential information. The indication or request may be transmitted via the user's 118 body to the personal mobile device 120. In certain embodiments, the indication or request may be transmitted through the user's 118 body using a first communications channel at approximately 125 KHz. However, it will be appreciated that any other frequency for the first communications channel is possible. Additionally, in certain embodiments, upon detecting the capacitance change, the capacitive sensor 110 may transmit a signal to the processor(s) 104 that causes the processor(s) 104 to switch the user device 102 from a first power state to a second power state. For example, the user device 102 may initially be in a sleep state or other lower power state. Upon detecting the capacitance change due to the touch interaction by the user 118, the user device 102 may “wake-up” and switch to full power and/or a relatively higher power state.

Furthermore, as previously discussed, the personal mobile device 120 may be coupled to, attached to, and/or otherwise in contact with the user's 118 body. As such, the capacitive transceiver 126 on the personal mobile device 120 may be configured to receive the indication or request from the transmitter 112 on the user device 102. In some implementations, the indication or request may include a device identifier associated with the user device 102. The device identifier may include any type of data that identifies the user device 102 such as a media access control (MAC) address and/or the like. Upon receipt of the indication or request, the capacitive transceiver 126 may be configured to identify credential information associated with the user 118. Additionally, the credential information may be transmitted through the user's 118 body to the capacitive sensor 110 on the user device 102. Such credential information may be stored in memory 124 and/or any other storage location in communication with the personal mobile device 120. In some implementations, the credential information may include login information to log in to the operating system of the user device 102. For example, the credential information may include data associated with a user identifier, a user password, biometric data of the user 118, encryption information, and/or the like. In certain implementations, the credential information may be determined based at least in part on the device identifier received in the initial indication or request. As such, the personal mobile device 120 (e.g., the capacitive transceiver 126) may determine the appropriate credential information based on the device identifier associated with the user device 102.

In certain embodiments, the credential information may be transmitted via the user's 118 body using a second communications channel at approximately 8 Mhz. However, it will be appreciated that any other frequencies for the second communications channel are also contemplated and that the first communications channel and the second communications channel may also operate at the same frequency. While the user 118 may be still touching and/or otherwise in contact with the capacitive sensor 110, the capacitive sensor 110 may be configured to receive the credential information via the user's 118 body and the second communications channel. To this end, the capacitive sensor 110 may be configured to transmit and/or otherwise provide the credential information to the login application 108. The login application 108 may be configured to log in to the operating system using the credential information. In some implementations, the login application 108 may be included as part of the operating system of the user device 102.

As illustrated by FIG. 1 and described above, the system 100 may facilitate communication between the user device 102 and the personal mobile device 120 through the establishment of a BAN through the user's body. The system 100 may further enable the user 118 to log in to the operating system of the user device 102 by simply touching a capacitive sensor 110 coupled to the user device 102 while also in contact with the personal mobile device 120 (e.g., and/or the capacitive transceiver 126). As such, the user 118 may avoid having to remember multiple credential information (e.g., login information such as user identifiers and passwords). Furthermore, since the login procedure may be automated upon a user's 118 touch interaction, the user 118 may also avoid manually inputting the credential information. Moreover, since the credential information may be transmitted via the user's 118 body, the credential information may be transmitted in a relatively secure manner compared with wireless transmission through the air.

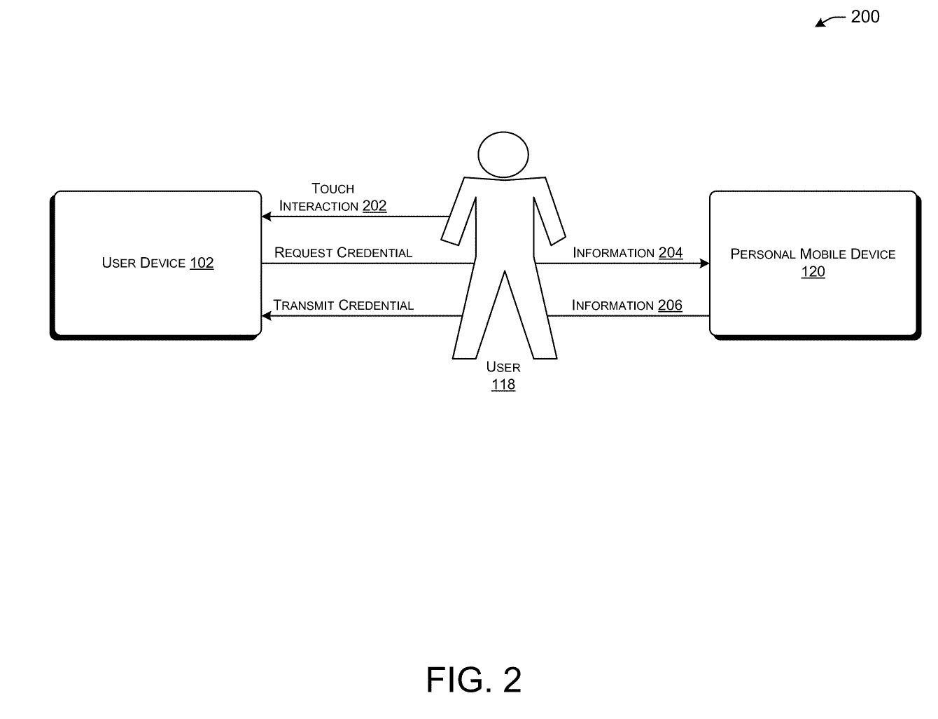

FIG. 2 provides a diagram illustrating a data flow 200 for using a body area network to communicate between a user 118, a user device 102, and a personal mobile device 120 in accordance with one or more example embodiments. The data flow 200 may describe a process by which the user 118 may log in to an operating system of the user device 102.

In accordance with one or more embodiments of the data flow 200, a user 118 may initiate a touch interaction 202 with a user device 102. For example, the user 118 may touch a capacitive sensor 110 included on the user device 102. As such, the capacitive sensor 110 may determine a change in capacitance as a result of the touch interaction 202. Upon determining the capacitance change, the capacitive sensor 110 may be configured to transmit a request for credential information 204 to the personal mobile device 120. In certain embodiments, the user's 118 body may be used as a communications medium, and the request for credential information 204 may be transmitted through the user's 118 body to the personal mobile device 120. Furthermore, in other implementations, upon determining the capacitance change, the capacitive sensor 110 may cause the user device 102 to switch from a first power state to a second power state (e.g., “wake up” from a sleep state to a full-power state).

The personal mobile device 120 may receive the request for credential information 204, such as by the capacitive transceiver 126. For example, the personal mobile device 120 may be attached to and/or otherwise in contact with the user 118 while the user 118 touches the capacitive sensor 110 on the user device 102. In response to the request for credential information 204, the personal mobile device 120 (e.g., the capacitive transceiver 126) may be configured to transmit the credential information 206, via the user's body 118, to the capacitive sensor 110 on the user device 102. In certain embodiments, the request for credential information 204 may be transmitted to the personal mobile device 120 over a first communications channel, and the response may be transmitted over a second communications channel. To this end, the first communications channel may operate in a frequency channel at approximately 125 KHz while the second communications channel may operate in a frequency channel at approximately 8 Mhz. It will be appreciated, however, that other combinations of frequency channels for the first communications channel and the second communications channel are also possible, including operation of both communications channels in the same frequency channel.

It will be appreciated that the data flow 200 illustrated in FIG. 2 is not limited to any particular sequence and that communication between the user 118, the user device 102, and the personal mobile device 120 may be interleaved in any combination. Furthermore, it will be appreciated that in some implementations, communication between the user device 102 and the personal mobile device 120 may be performed using short-wavelength radio signals (e.g., Bluetooth and/or Bluetooth Low-Energy). However, any other type of wireless signals are also contemplated and may be transmitted and/or received as broadcast signals, connection requests, and/or connection responses.

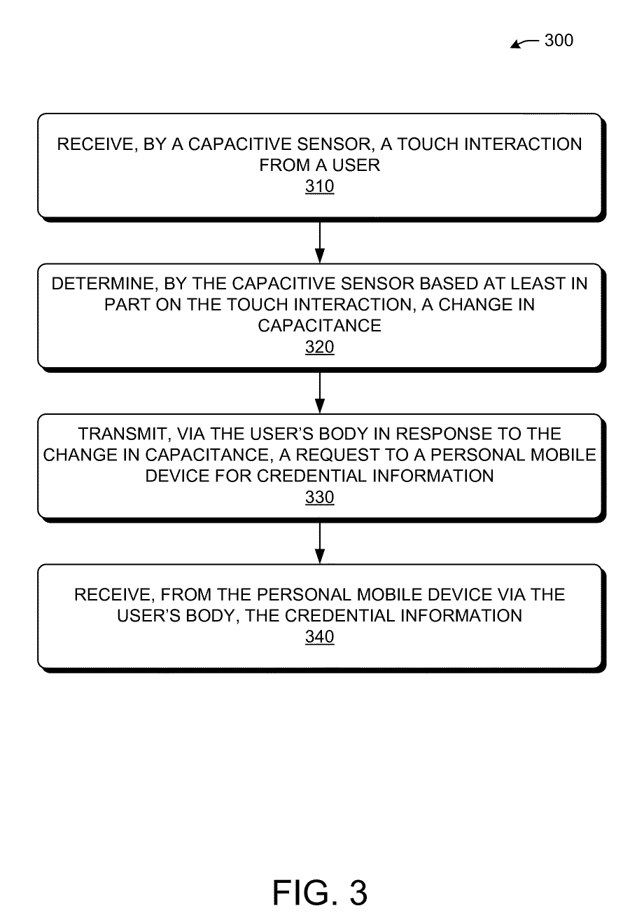

Referring now to FIG. 3, a flow diagram of a method 300 is illustrated for communication using a body area network in accordance with one or more example embodiments. The method 300 may generally describe operations from the perspective of a user device, such as the user device 102. As such, the method 300 may begin in block 310, where a user device 102 may be configured to receive, by a capacitive sensor 110, a touch interaction from a user 118. For instance, the user 118 may touch, swipe, and/or otherwise initiate a touch event on the capacitive sensor 110. In block 320, the capacitive sensor 110 may be configured to determine, based at least in part on the touch interaction, a change in capacitance (e.g., of the capacitive sensor 110). For example, the capacitive sensor 110 may include an electrode 111 to facilitate such a determination.

In block 330, the capacitive sensor 110 may transmit (e.g., via a transmitter 112), via the user's 118 body in response to the change in capacitance, a request to a personal mobile device 120 for credential information. In certain implementations, upon determination of the change in capacitance, the user device 102 may also switch from a first power state to a second power state (e.g., from a sleep state to a full-power state). In block 340, the user device 102 may receive, from the personal mobile device 120 via the user's 118 body, the credential information. According to certain implementations, the credential information may be used to log in to an operating system stored on the user device 102.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Examples

Example 1 is a system for establishing secure communication, comprising: a capacitive sensor; at least one processor; and at least one memory storing computer-executable instructions, that when executed by the at least one processor, causes that at least one processor to: receive, by the capacitive sensor, a touch interaction from a user; determine, by the capacitive sensor based at least in part on the touch interaction, a change in capacitance; transmit, via the user's body in response to the change in capacitance, a request to a personal mobile device for credential information; and receive, from the personal mobile device via the user's body, the credential information.

In Example 2, the subject matter of Example 1 can optionally include that the at least one memory further comprises computer-executable instructions that cause the at least one processor to: switch, in response to the change in capacitance, from a first power state to a second power state.

In Example 3, the subject matter of Example 2 can optionally include that the first power state is at least one of a sleep state or a low-power state.

In Example 4, the subject matter of Example 1 can optionally include that the at least one memory further comprises computer-executable instructions that cause the at least one processor to: log in to an operating system using the credential information, the operating system stored in the at least one memory.

In Example 5, the subject matter of Example 1 can optionally include that the at least one memory further comprises computer-executable instructions that cause the at least one processor to: access, based at least in part on the credential information, a user profile associated with the user.

In Example 6, the subject matter of Example 1 can optionally include that the credential information comprises biometric data associated with the user.

In Example 7, the subject matter of Example 1 can optionally include that the personal mobile device comprises at least one of a smartphone, a tablet, a personal data assistant, a watch, a necklace, a headband, a bracelet, a pin, a badge, a belt, or a ring.

In Example 8, the subject matter of Example 1 can optionally include that the credential information is transmitted via the user's body using a first communications channel and received via the user's body using a second communications channel.

Example 9 is a method for establishing secure communication, comprising: receiving, by a computer comprising one or more processors and a capacitive sensor, a touch interaction from a user; determining, by the capacitive sensor based at least in part on the touch interaction, a change in capacitance; transmitting, via the user's body in response to the change in capacitance, a request to a personal mobile device for credential information; and receiving, from the personal mobile device via the user's body, the credential information.

In Example 10, the subject matter of Example 9 can optionally include switching, in response to the change in capacitance, the computer from a first power state to a second power state.

In Example 11, the subject matter of Example 10 can optionally include that the first power state is at least one of a sleep state or a low-power state.

In Example 12, the subject matter of Example 9 can optionally include logging in to an operating system using the credential information, the operating system stored in the computer.

In Example 13, the subject matter of Example 9 can optionally include accessing, based at least in part on the credential information, a user profile associated with the user.

In Example 14, the subject matter of Example 9 can optionally include that the credential information comprises biometric data associated with the user.

In Example 15, the subject matter of Example 9 can optionally include that the personal mobile device comprises at least one of a smartphone, a tablet, a personal data assistant, a watch, a necklace, a headband, a bracelet, a pin, a badge, a belt, or a ring.

In Example 16, the subject matter of Example 9 can optionally include transmitting the credential information via the user's body using a first communications channel; and receiving the credential information via the user's body using a second communications channel.

Example 17 is a non-transitory computer-readable medium comprising instructions, that when executed by at least one processor, cause the at least one processor to: receive, by a capacitive sensor, a touch interaction from a user; determine, by the capacitive sensor based at least in part on the touch interaction, a change in capacitance; transmit, via the user's body in response to the change in capacitance, a request to a personal mobile device for credential information; and receive, from the personal mobile device via the user's body, the credential information.

In Example 18, the subject matter of Example 17 can optionally include computer-executable instructions that cause the at least one processor to: switch, in response to the change in capacitance, from a first power state to a second power state.

In Example 19, the subject matter of Example 18 can optionally include that the first power state is at least one of a sleep state or a low-power state.

In Example 20, the subject matter of Example 17 can optionally include computer-executable instructions that cause the at least one processor to: log in to an operating system using the credential information, the operating system stored in the at least one memory.

In Example 21, the subject matter of Example 17 can optionally include computer-executable instructions that cause the at least one processor to: access, based at least in part on the credential information, a user profile associated with the user.

In Example 22, the subject matter of Example 17 can optionally include that the credential information comprises biometric data associated with the user.

In Example 23, the subject matter of Example 17 can optionally include that the personal mobile device comprises at least one of a smartphone, a tablet, a personal data assistant, a watch, a necklace, a headband, a bracelet, a pin, a badge, a belt, or a ring.

In Example 24, the subject matter of Example 17 can optionally include that the credential information is transmitted via the user's body using a first communications channel and received via the user's body using a second communications channel.

Example 25 is a mobile device, comprising: a transceiver; at least one processor; and at least one memory storing computer-executable instructions, that when executed by the at least one processor, causes the at least one processor to: receive, from a user device via a user's body, an indication to transmit credential information associated with the user; and transmit, by the transceiver via the user's body, the credential information to the user device.

In Example 26, the subject matter of Example 25 can optionally include that the at least one memory further comprises computer-executable instructions that cause the at least one processor to: receive the indication via the user's body using a first communications channel; and transmit the credential information via the user's body using a second communications channel.

In Example 27, the subject matter of Example 25 can optionally include that the mobile device is attached to the user's body.

In Example 28, the subject matter of Example 25 can optionally include at least one of a smartphone, a tablet, a personal data assistant, a watch, a necklace, a headband, a bracelet, a pin, a badge, a belt, or a ring.

Example 29 is an apparatus, comprising: means for receiving a touch interaction from a user; means for determining, based at least in part on the touch interaction, a change in capacitance; means for transmitting, via the user's body in response to the change in capacitance, a request to a personal mobile device for credential information; and means for receiving, from the personal mobile user device via the user's body, the credential information.

In Example 30, the subject matter of Example 29 can optionally include means for switching, in response to the change in capacitance, the computer from a first power state to a second power state.

In Example 31, the subject matter of Example 30 can optionally include that the first power state is at least one of a sleep state or a low-power state

In Example 32, the subject matter of Example 29 can optionally include means for logging in to an operating system using the credential information, the operating system stored in the computer.

In Example 33, the subject matter of Example 29 can optionally include that the credential information comprises login information associated with the user and the operating system.

In Example 34, the subject matter of Example 29 can optionally include that the credential information comprises biometric data associated with the user.

In Example 35, the subject matter of Example 29 can optionally include that the personal mobile device comprises at least one of a smartphone, a tablet, a personal data assistant, a watch, a necklace, a headband, a bracelet, a pin, a badge, a belt, or a ring.

In Example 36, the subject matter of Example 29 can optionally include means for transmitting the credential information via the user's body using a first communications channel; and means for receiving the credential information via the user's body using a second communications channel.

Example 37 is a method for transmitting credential information, comprising: receiving, by a computer comprising one or more processors from a user device via a user's body, an indication to transmit credential information associated with the user; and transmitting, via the user's body, the credential information to the user device.

In Example 38, the subject matter of Example 37 can optionally include receiving the indication via the user's body using a first communications channel; and transmitting the credential information via the user's body using a second communications channel.

In Example 39, the subject matter of Example 37 can optionally include that the computer comprises a mobile device attached to the user's body.

In Example 40, the subject matter of Example 37 can optionally include that the computer comprises at least one of a smartphone, a tablet, a personal data assistant, a watch, a necklace, a headband, a bracelet, a pin, a badge, a belt, or a ring.

1. A system for establishing secure communication, comprising:
a capacitive sensor;
at least one processor; and
at least one memory storing computer-executable instructions, that when executed by the at least one processor, causes the at least one processor to:
receive, by the capacitive sensor, a touch interaction from a user;
determine, by the capacitive sensor based at least in part on the touch interaction, a change in capacitance;
transmit, via the user's body in response to the change in capacitance, a request to a personal mobile device for credential information; and
receive, from the personal mobile device via the user's body, the credential information,
wherein the credential information is transmitted via the user's body using a first communications channel and received via the user's body using a second communications channel.

2. The system of claim 1, wherein the at least one memory further comprises computer-executable instructions that cause the at least one processor to:
switch, in response to the change in capacitance, from a first power state to a second power state.

3. The system of claim 2, wherein the first power state is at least one of a sleep state or a low-power state.

4. The system of claim 1, wherein the at least one memory further comprises computer-executable instructions that cause the at least one processor to:
log in to an operating system using the credential information, the operating system stored in the at least one memory.

5. The system of claim 1, wherein the at least one memory further comprises computer-executable instructions that cause the at least one processor to:
access, based at least in part on the credential information, a user profile associated with the user.

6. The system of claim 1, wherein the credential information comprises biometric data associated with the user.

7. The system of claim 1, wherein the personal mobile device comprises at least one of a smartphone, a tablet, a personal data assistant, a watch, a necklace, a headband, a bracelet, a pin, a badge, a belt, or a ring.

8. (canceled)

9. A method for establishing secure communication, comprising:
receiving, by a computer comprising one or more processors and a capacitive sensor, a touch interaction from a user;
determining, by the capacitive sensor based at least in part on the touch interaction, a change in capacitance;
transmitting, via the user's body in response to the change in capacitance, a request to a personal mobile device for credential information using a first communications channel; and
receiving, from the personal mobile device via the user's body, the credential information using a second communications channel.

10. The method of claim 9, further comprising:
switching, in response to the change in capacitance, the computer from a first power state to a second power state.

11. The method of claim 10, wherein the first power state is at least one of a sleep state or a low-power state.

12. The method of claim 9, further comprising:
logging in to an operating system using the credential information, the operating system stored in the computer.

13. The method of claim 9, further comprising:
accessing, based at least in part on the credential information, a user profile associated with the user.

14. The method of claim 9, wherein the credential information comprises biometric data associated with the user.

15. The method of claim 9, wherein the personal mobile device comprises at least one of a smartphone, a tablet, a personal data assistant, a watch, a necklace, a headband, a bracelet, a pin, a badge, a belt, or a ring.

16. (canceled)

17. A non-transitory computer-readable medium comprising instructions, that when executed by at least one processor, cause the at least one processor to:
receive, by a capacitive sensor, a touch interaction from a user;
determine, by the capacitive sensor based at least in part on the touch interaction, a change in capacitance;
transmit, via the user's body in response to the change in capacitance, a request to a personal mobile device for credential information; and
receive, from the personal mobile device via the user's body, the credential information,
wherein the credential information is transmitted via the user's body using a first communications channel and received via the user's body using a second communications channel.

18. The computer-readable medium of claim 17, further comprising computer-executable instructions that cause the at least one processor to:
switch, in response to the change in capacitance, from a first power state to a second power state.

19. The computer-readable medium of claim 18, wherein the first power state is at least one of a sleep state or a low-power state.

20. The computer-readable medium of claim 17, further comprising computer-executable instructions that cause the at least one processor to:
log in to an operating system using the credential information, the operating system stored in the at least one memory.

21. The computer-readable medium of claim 17, further comprising computer-executable instructions that cause the at least one processor to:
access, based at least in part on the credential information, a user profile associated with the user.

22. The computer-readable medium of claim 17, wherein the credential information comprises biometric data associated with the user.

23. The computer-readable medium of claim 17, wherein the personal mobile device comprises at least one of a smartphone, a tablet, a personal data assistant, a watch, a necklace, a headband, a bracelet, a pin, a badge, a belt, or a ring.

24. (canceled)

25. A mobile device, comprising:
a transceiver;
at least one processor; and
at least one memory storing computer-executable instructions, that when executed by the at least one processor, causes the at least one processor to:
receive, from a user device via a user's body using a first communications channel, an indication to transmit credential information associated with the user; and
transmit, by the transceiver via the user's body using a second communications channel, the credential information to the user device.

26. (canceled)

27. The mobile device of claim 25, wherein the mobile device is attached to the user's body.

28. The mobile device of claim 25, further comprising at least one of a smartphone, a tablet, a personal data assistant, a watch, a necklace, a headband, a bracelet, a pin, a badge, a belt, or a ring.
